(19) United States
(12) Patent Application Publication
(10) Pub. No.: US 2026/0277998 A1
(43) Pub. Date: Sep. 17, 2026

(54) AUDIO COPY DETECTION

(71) Applicant: TENCENT TECHNOLOGY (SHENZHEN) COMPANY LIMITED, Shenzhen (CN)

(72) Inventor: Jinchang XU, Shenzhen (CN)

(73) Assignee: TENCENT TECHNOLOGY (SHENZHEN) COMPANY LIMITED, Shenzhen (CN)

(21) Appl. No.: 19/678,064

(22) Filed: May 14, 2026

Related U.S. Application Data
(63) Continuation of application No. PCT/CN2025/115349, filed on Aug. 18, 2025.

(30) Foreign Application Priority Data
Aug. 20, 2024 (CN) 202411142927.9

(51) Int. Cl. G06F 16/783; G06F 16/683; G06F 16/78

(52) U.S. Cl. CPC G06F 16/7834; G06F 16/685; G06F 16/7867

(57) ABSTRACT

A first global audio feature of a first audio and a first audio segment feature sequence of the first audio are extracted. The first global audio feature indicates an attribute of the first audio as a whole, and the first audio segment feature sequence indicates time-based local features in the first audio. An approximate global audio feature corresponding to the first global audio feature is retrieved from an audio retrieval library, the approximate global audio feature is associated with a target audio. A second audio segment feature sequence of the target audio is obtained. An audio similarity between the first audio and the target audio is determined based on the first audio segment feature sequence of the first audio and the second audio segment feature sequence of the target audio. The target audio is determined as an audio copy of the first audio when the audio similarity satisfies a requirement.

### RELATED APPLICATIONS

The present application is a continuation of International Application No. PCT/CN2025/115349, filed on Aug. 18, 2025, which claims priority to Chinese Patent Application No. 202411142927.9, filed on Aug. 20, 2024. The entire disclosures of the prior applications are hereby incorporated by reference.

### FIELD OF THE TECHNOLOGY

This disclosure relates to the field of artificial intelligence technologies, including an audio copy detection method and apparatus, an electronic device, a computer storage medium, and a computer program product.

### BACKGROUND

An audio copy detection technology is a technology for identifying whether audio content is similar to or the same as a known audio. If it is identified that audio content is similar to or the same as the known audio, the known audio may be considered as a copy of a to-be-identified audio. The audio copy detection technology is usually applied to application scenarios such as audio copyright protection and music recommendation. In a related technology, matching of a global audio feature is usually relied on when an audio copy is detected, which has a single detection dimension, and a detailed difference of audios is easily ignored, resulting in low detection accuracy. How to improve the accuracy of audio copy detection is still a technical problem that needs to be researched and resolved.

### SUMMARY

To address the foregoing technical problem, embodiments of this disclosure include an audio copy detection method, an audio copy detection apparatus, an electronic device, a computer-readable storage medium (e.g., non-transitory computer-readable storage medium), and a computer program product. Embodiments of this disclosure can improve the accuracy of audio copy detection.

Some aspects of the disclosure provide a method of audio copy detection. In some examples, a first global audio feature of a first audio and a first audio segment feature sequence of the first audio are extracted. The first global audio feature indicates an attribute of the first audio as a whole, and the first audio segment feature sequence indicates time-based local features in the first audio. An approximate global audio feature corresponding to the first global audio feature is retrieved from an audio retrieval library, the approximate global audio feature is associated with a target audio. A second audio segment feature sequence of the target audio is obtained. An audio similarity between the first audio and the target audio is determined based on the first audio segment feature sequence of the first audio and the second audio segment feature sequence of the target audio. The target audio is determined as an audio copy of the first audio when the audio similarity satisfies a requirement.

Some aspects of the disclosure provide an apparatus that includes processing circuitry configured to perform any of the methods described herein.

Some aspects of the disclosure provide a non-transitory computer-readable storage medium storing instructions which when executed by at least one processor cause the at least one processor to perform any of the methods described herein.

According to one aspect of the embodiments of this disclosure, an audio copy detection method is provided, the method is performed by an electronic device, and the method includes: extracting a global audio feature corresponding to a to-be-processed audio, and extracting an audio segment feature sequence corresponding to the to-be-processed audio; retrieving an approximate global audio feature corresponding to the global audio feature from an audio retrieval library; obtaining an audio segment feature sequence corresponding to a target audio to which the approximate global audio feature belongs, and determining an audio similarity between the to-be-processed audio and the target audio based on the audio segment feature sequences respectively corresponding to the to-be-processed audio and the target audio; and determining the target audio as the audio copy corresponding to the to-be-processed audio if the audio similarity reaches or exceeds a preset similarity (also referred to as satisfies a similarity requirement).

According to another aspect of the embodiments of this disclosure, an audio copy detection apparatus is provided. The apparatus includes a feature extraction module, configured to extract a global audio feature corresponding to a to-be-processed audio, and extract an audio segment feature sequence corresponding to the to-be-processed audio; a feature retrieval module, configured to retrieve an approximate global audio feature corresponding to the global audio feature from an audio retrieval library, and obtain an audio segment feature sequence corresponding to a target audio to which the approximate global audio feature belongs; a similarity determining module, configured to determine an audio similarity between the to-be-processed audio and the target audio based on the audio segment feature sequence corresponding to the to-be-processed audio and the audio segment feature sequence corresponding to the target audio; and a copy determining module, configured to determine the target audio as the audio copy corresponding to the to-be-processed audio if the audio similarity reaches or exceeds a preset similarity.

Another aspect of the embodiments of this disclosure provides an electronic device, including one or more processors; and a memory, configured to store one or more computer programs, the one or more computer programs, when executed by the one or more processors, causing the electronic device to implement the audio copy detection method described above.

Another aspect of the embodiments of this disclosure provides a computer-readable storage medium, having a computer program stored herein, the computer program, when executed by a processor (an example of processing circuitry) of an electronic device, causing the electronic device to implement the audio copy detection method described above.

Another aspect of the embodiments of this disclosure provides a computer program product, including a computer program, the computer program, when executed by a processor of an electronic device, implementing the audio copy detection method described above.

In the technical solution provided in this embodiment of this disclosure, an approximate global audio feature is first retrieved from an audio retrieval library according to a global audio feature of a to-be-processed audio, and then an audio similarity between the to-be-processed audio and the target audio is determined based on the audio segment feature sequences respectively corresponding to the to-be-processed audio and the target audio. This may be understood as that a general attribute of the audio is reflected through the global audio feature, thereby implementing detection of a coarser granularity, quickly narrowing a detection range in the audio retrieval library, and improving detection efficiency. Then, local details and time sequence association of the audio are captured through the audio segment feature sequence, thereby implementing detection of a finer granularity, so that detection is focused on potential similar audios, thereby enhancing pertinence of the detection. Detection of the global audio feature and detection of the audio segment feature sequence are combined to reduce misjudgment caused by a single feature, thereby helping to ensure accuracy of audio copy detection. Whether the target audio is an audio copy of the to-be-processed audio is determined based on whether the audio similarity reaches the preset similarity, so that a determining process has a clear quantization standard, thereby reducing interference from subjective factors, and helping to ensure consistency and reliability of a detection result.

The foregoing general descriptions and the following detailed descriptions are examples only, and are not intended to limit this disclosure.

### BRIEF DESCRIPTION OF THE DRAWINGS

FIG. 1 is a schematic diagram of an implementation environment according to an embodiment of this disclosure.

FIG. 2 is a first flowchart of an audio copy detection method according to an embodiment of this disclosure.

FIG. 3 is a second flowchart of an audio copy detection method according to an embodiment of this disclosure.

FIG. 4 is a schematic flowchart of extracting a global audio feature corresponding to a to-be-processed audio according to an embodiment of this disclosure.

FIG. 5 is a schematic diagram of audio classification distribution included in a video posted by a user on a video posting platform according to an embodiment of this disclosure.

FIG. 6 is a flowchart of processing an audio identifier based on a video posting platform according to an embodiment of this disclosure.

FIG. 7 is a schematic architectural diagram of a principle of adding an audio identifier to a video posted on a video posting platform according to an embodiment of this disclosure.

FIG. 8 is a flowchart of processing an audio identifier based on a video posting platform according to an embodiment of this disclosure.

FIG. 9 is a flowchart of a video processing method according to an embodiment of this disclosure.

FIG. 10 is a schematic diagram of a jump of a front-end interface of a video posting platform according to an embodiment of this disclosure.

FIG. 11 is a block diagram of an audio copy detection apparatus according to an embodiment of this disclosure.

FIG. 12 is a schematic structural diagram of a computer system configured to implement an electronic device according to an embodiment of this disclosure.

The foregoing “first” and “second” are to distinguish between different solutions, and do not represent superiorities of the solutions or priorities in an implementation process.

### DETAILED DESCRIPTION

The following describes technical solutions in embodiments of this disclosure with reference to the accompanying drawings. The described embodiments are some of the embodiments of this disclosure rather than all of the embodiments. Other embodiments are within the scope of this disclosure.

Examples of terms involved in the aspects of the disclosure are briefly introduced. The descriptions of the terms are provided as examples only and are not intended to limit the scope of the disclosure.

Embodiments are described herein, and examples of the embodiments are shown in the accompanying drawings. When the following description relates to the accompanying drawings, unless otherwise stated, the same reference numerals in different accompanying drawings represent the same or similar elements. The implementations described in the following embodiments do not represent all implementations consistent with this disclosure. On the contrary, the implementations are examples of an apparatus and a method that are consistent with some aspects of this disclosure as detailed in the appended claims.

The block diagrams shown in the accompanying drawings are functional entities and do not necessarily correspond to physically independent entities. To be specific, the functional entities may be implemented in a software form, or in one or more hardware modules or integrated circuits, or in at least one of different networks, processor apparatuses, and microcontroller apparatuses.

The flowcharts shown in the accompanying drawings are merely examples, and do not necessarily include at least one of all content and operations and steps, nor do they have to be executed in the described order. For example, at least one of some operations and steps may be further divided, while at least one of some operations and steps may be combined or partially combined. Therefore, an actual execution order may change according to an actual case.

“Plurality of” mentioned in this disclosure means two or more. “At least one of” means an association relationship for describing associated objects and represents that three relationships may exist. For example, at least one of A and B may represent the following three cases: only A exists, both A and B exist, and only B exists. The character “/” generally indicates an “or” relationship between a preceding associated object and a succeeding associated object.

The terms such as “first”, “second”, “third”, and “fourth” in the specification and claims of this disclosure and in the accompanying drawings are used to distinguish between different objects, rather than being used to describe a specific order. Terms “include”, “have”, and any variant thereof are intended to cover a non-exclusive inclusion. For example, processes, methods, systems, products, or devices including a series of operations or units are not limited to the listed operations or units, but instead, include other operations or units not listed in some embodiments, or include other operations or units inherent to these processes, methods, products, or devices in some embodiments.

In embodiments of this disclosure, the term “module” or “unit” refers to a computer program or a part of the computer program that has a predetermined function, and operates together with another relevant part to achieve a predetermined objective, and may be entirely or partially implemented by using software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or the unit.

During example application of the relevant data collection and processing in embodiments of this disclosure, the informed consent or individual consent of a personal information subject needs to be obtained in strict accordance with the requirements of relevant laws and regulations, and the subsequent data use and processing are carried out within the authorized scope of laws and regulations and the personal information subject.

Before the embodiments of this disclosure are further described, nouns and terms in the embodiments of this disclosure are described, and the nouns and the terms in the embodiments of this disclosure are applicable to the following explanations.

1) Global audio feature refers to a feature that is extracted by performing comprehensive and holistic analysis on an entire segment of an audio, can comprehensively reflect an attribute of the audio on the whole, and includes, but is not limited to, a whole spectrum distribution trend, a long time course energy change law, a macroscopic style feature, and the like. The global audio feature may be obtained after a trained feature extraction model processes a spectrogram sequence of the audio, and is an abstract representation of entire audio content.

2) Audio segment feature refers to a feature obtained by dividing an audio based on a preset unit duration, to obtain a plurality of consecutive audio segments, and then performing feature extraction on each audio segment. The audio segment feature can capture a local characteristic of an audio in a specific short time period, for example, detailed information such as a frequency component and an energy fluctuation in the time period, and each audio segment has a corresponding audio segment feature.

3) Audio segment feature sequence refers to a sequence formed by sequentially arranging and combining extracted audio features based on an inherent time sequence of audio segments in an original audio after an audio is segmented into a plurality of sequential audio segments based on a unit duration, and an audio feature is extracted for each audio segment. The audio segment feature sequence retains a local feature change situation of an audio in a time dimension, and can reflect time sequence association of local features of the audio.

4) Shallow feature refers to a feature generated by a shallow feature extraction network in a feature extraction model. The shallow feature extraction network outputs a shallow feature after performing initial processing on an inputted spectrogram or audio segment. The shallow feature is more focused on reflecting a basic feature and a surface layer feature of the audio, for example, relatively visual information such as a local texture in a spectrogram and short-time frequency distribution in an audio segment, and is the basis of subsequent feature processing.

5) Deep feature refers to a feature obtained after a deep feature extraction network further integrates, abstracts, and processes shallow features in a feature extraction model. The deep feature can penetrate surface layer information of the audio, reflect more abstract and complex global associations and internal rules of the audio, and is a more in-depth representation of an entire characteristic of the audio.

6) Audio similarity duration refers to that respective audio segment feature sequences of a to-be-processed audio and a target audio are carefully compared, and parts having similar content in the two audio segments are determined by analyzing a case in which features in the two audio segment feature sequences match each other. A total duration corresponding to these similar parts in a time dimension is the audio similarity duration, which can quantize and reflect a similarity degree between content of the two audio segments.

First, as described above, the audio copy detection technology is a technology configured for identifying whether audio content is similar to or the same as the known audio. In a related technology, audio copy detection is mainly implemented in the following modes.

1. Fingerprint feature-based detection mode: Audio fingerprint features need to be extracted to represent fingerprint content, and whether the audios are the same or similar audio may be determined by comparing similarities between audio fingerprints.

2. Time-domain feature-based detection mode: Time-domain features (for example, energy or a zero-crossing rate) of an audio need to be analyzed, and whether the audio is the same or similar audio is determined by calculating time-domain feature similarities between the audio.

3. Frequency-domain feature-based detection mode: Frequency-domain features (for example, a spectrum or a harmonic) of an audio need to be analyzed, and whether the audio is the same or similar audio is determined by calculating frequency-domain feature similarities between the audio.

4. Time-frequency domain feature-based detection mode: Time-frequency domain features (for example, a Mel-frequency cepstral coefficient and a tone frequency) of an audio need to be analyzed, and whether the audio is the same or similar audio is determined by calculating time-frequency domain feature similarities between the audio.

5. Deep learning-based detection mode: Audio features are encoded by using a deep learning model (for example, a convolutional neural network (CNN), a recurrent neural network, or a long short time memory network), and the audio features obtained through encoding are compared, to determine whether the audio is the same or similar audio.

In the deep learning-based detection mode, the deep learning model can automatically learn to obtain a high-level feature representation of an audio, thereby improving accuracy and robustness of copy detection. Therefore, in an audio copy detection solution provided in the embodiments of this disclosure, whether audio content is the same or similar is also determined in the deep learning-based detection mode.

The audio copy detection solution provided in the embodiments of this disclosure is described below in detail.

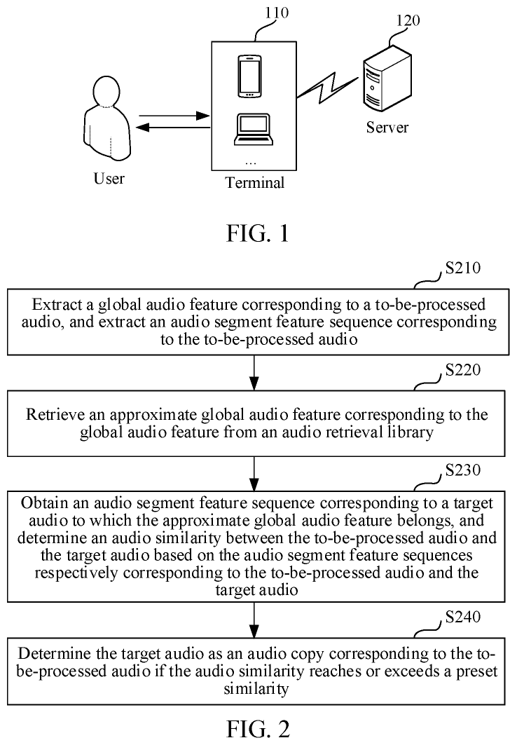

Referring to FIG. 1 first, FIG. 1 is a schematic diagram of an implementation environment according to an embodiment of this disclosure. The implementation environment includes a terminal 110 and a server 120. The terminal 110 and the server 120 communicate with each other through a wired or wireless manner.

The terminal 110 is a device that exchanges information with a user, and is configured to receive information inputted by the user, such as an audio, and return information to the user. For example, the terminal 110 is configured with a graphical user interface (GUI). A user may perform human-computer interaction with the terminal 110 through the GUI. For example, the user triggers the GUI to input information, and can also obtain needed information from the GUI. For another example, the terminal 110 may be configured with a device such as a keyboard or a mouse, to help implement information interaction with a user.

The server 120 is configured to provide data services for information interaction between the terminal 110 and the user. For example, the terminal 110 uploads an audio inputted by a user to the server 120, so that the server 120 performs detection on an audio copy that is the same as or similar to the audio inputted by the user, and returns a detection result to the terminal 110. After receiving information transmitted by the server 120, the terminal 110 returns the information to the user.

When the terminal 110 has no data service requirement, the terminal 110 may not exchange data with the server 120. For example, after receiving a video inputted by a user, the terminal 110 may directly perform detection on an audio copy that is the same as or similar to the audio inputted by the user, and return a detection result to the user.

The terminal 110 may be a device such as a smartphone, a tablet computer, a notebook computer, a computer, a smart household appliance, an intelligent terminal, and the like. The server 120 may be an independent physical server, or may be a server cluster composed of a plurality of physical servers or a distributed system, and may further be a cloud server providing a basic cloud computing service. This is not limited in embodiments of this disclosure.

FIG. 2 is a first flowchart of an audio copy detection method according to an embodiment of this disclosure. The method may be applied to the implementation environment shown in FIG. 1, for example, may be performed by the server 120, or may be performed by the terminal 110, or may be jointly performed by the terminal 110 and the server 120. The method may alternatively be applied to another implementation environment, and is performed by a terminal or a server in another implementation environment, or is jointly performed by the terminal and the server in another implementation environment. This is not limited in this embodiment.

As shown in FIG. 2, in an embodiment, the audio copy detection method includes S210 to S240. Details are described as follows.

S210: Extract a global audio feature corresponding to a to-be-processed audio, and extract an audio segment feature sequence corresponding to the to-be-processed audio.

First, the global audio feature disclosed in this embodiment represents an overall property of an audio. The global audio feature usually needs to be extracted through a multilayer neural network. Therefore, the global audio feature may also be understood as a deep feature.

The audio segment feature sequence disclosed in this embodiment is formed by arranging a plurality of audio segment features based on a time sequence. For example, the audio is divided into a plurality of audio segments, then audio features of the audio segments are respectively extracted, and the audio features are sorted based on the time sequence, to obtain a corresponding audio segment feature sequence.

In this embodiment, based on the global audio feature corresponding to the to-be-processed audio, recall of target audio similar to the to-be-processed audio may be implemented. Based on the audio segment feature sequence corresponding to the to-be-processed audio, whether the recalled target audio is similar to the to-be-processed audio may be further verified, thereby helping to ensure relatively high accuracy of an obtained detection result.

For example, if the to-be-processed audio is a song whose duration is 3 minutes, the global audio feature extracted through the multilayer neural network may be a 128-dimensional deep feature, which comprehensively represents global properties such as an overall style and a tempo framework of the song. 360 audio segments are obtained after the song is segmented based on 0.5 second segments, a 64-dimensional audio segment feature corresponding to each audio segment is extracted, and a plurality of audio segment features are arranged as an audio segment feature sequence based on a time sequence of the audio segments in the song. The audio segment feature sequence includes 360 audio segment features of 64-dimensional vectors.

S220: Retrieve an approximate global audio feature corresponding to the global audio feature from an audio retrieval library.

The audio retrieval library has global audio features of a large quantity of known audios stored therein. The global audio feature of the known audio and the global audio feature of the to-be-processed audio are extracted in the same feature extraction mode.

For example, by calculating a similarity between the global audio feature of the to-be-processed audio and the global audio feature of the known audio, a global audio feature of the known audio whose similarity is greater than or equal to the preset threshold may be determined as an approximate global audio feature, and the known audio whose similarity is greater than or equal to the preset threshold is referred to as the target audio. Alternatively, each of the global audio features of the to-be-processed audio and the known audio is converted into a hash value, and whether the two global audio features are the same or similar is quickly determined by comparing the hash values.

For example, a known audio corresponding to a highest similarity may alternatively be used as the target audio. For the global audio feature of each known audio, the similarity between the global audio feature of the to-be-processed audio and the global audio feature of the known audio may be implemented through any one of the following algorithms: a cosine similarity, a Euclidean distance, a Manhattan distance, and a Pearson correlation coefficient. Using the cosine similarity as an example, a vector product of the global audio feature of the to-be-processed audio and the global audio feature of the known audio is determined; a length product of a length of the global audio feature of the to-be-processed audio and a length of the global audio feature of the known audio is determined; and a ratio of the vector product to the length product is determined as the similarity. For example, if the global audio feature of the to-be-processed audio is m and the global audio feature of the known audio is n, the vector product is m*n. If the length of the global audio feature of the to-be-processed audio is |m| and the length of the global audio feature of the known audio is |n|, the length product is |m|*|n|. The ratio of the vector product to the length product is (m*n)/(|m|*|n|), and is used as the similarity. Using an example in which the global audio feature is selected by comparing the hash values, the global audio feature of the to-be-processed audio is mapped to a first hash value through a hash function, and the global audio feature of the known audio is mapped to a second hash value, to determine a Hamming distance between the first hash value and the second hash value. If the Hamming distance is greater than zero and less than a Hamming distance threshold, it is determined that the global audio feature of the to-be-processed audio is similar to the global audio feature of the known audio. If the Hamming distance is equal to zero, it is determined that the global audio feature of the to-be-processed audio is the same as the global audio feature of the known audio. If the Hamming distance is greater than or equal to the Hamming distance threshold, it is determined that the global audio feature of the to-be-processed audio is neither the same nor similar to the global audio feature of the known audio.

In the audio retrieval library, there may be one or more approximate global audio features, or there may be no approximate global audio feature. A quantity of the approximate global audio features obtained through retrieval is not limited in this embodiment. When the approximate global audio feature does not exist, the to-be-processed audio is a new audio relative to the audio retrieval library.

S230: Obtain an audio segment feature sequence corresponding to a target audio to which the approximate global audio feature belongs, and determine an audio similarity between the to-be-processed audio and the target audio based on the audio segment feature sequences respectively corresponding to the to-be-processed audio and the target audio.

In this embodiment, the known audio also corresponds to the global audio feature and the audio segment feature sequence. An extraction mode of the global audio feature and the audio segment feature sequence corresponding to the known audio may be the same as an extraction mode of the global audio feature and the audio segment feature sequence corresponding to the to-be-processed audio.

In some embodiments, both the global audio feature and the audio segment feature sequence of the known audio may be stored in the audio retrieval library, and may be associatively stored. Therefore, after the approximate global audio feature is retrieved from the audio retrieval library, the audio retrieval library may be searched for an audio segment feature sequence associated with the approximate global audio feature, to obtain an audio segment feature sequence corresponding to a target audio to which the approximate global audio feature belongs.

For example, in the audio retrieval library, a key-value pair may be stored between the global audio feature of the known audio and the audio segment feature sequence. The global audio feature is used as a key, and each audio segment feature forming the audio segment feature sequence is used as a different value.

Alternatively, the global audio feature and the audio segment feature sequence of the known audio may be respectively stored in the audio retrieval library. For example, each global audio feature and each audio segment feature sequence stored in the audio retrieval library respectively have an audio identifier, and audios corresponding to the same audio identifier is also to be the same or similar.

Therefore, in some embodiments, after an audio copy corresponding to the to-be-processed audio is detected, an audio identifier corresponding to the audio copy is further used as the audio identifier corresponding to the to-be-processed audio, and the global audio feature and the audio segment feature sequence corresponding to the to-be-processed audio are stored in the audio retrieval library based on the audio identifier corresponding to the to-be-processed audio.

In some other embodiments, the audio segment feature sequence of the known audio is stored in another database different from the audio retrieval library. For example, each known audio has an audio identifier. The audio identifier of the known audio is associatively stored with the global audio feature of the known audio in the audio retrieval library, and the audio identifier of the known audio is associatively stored with the audio segment feature sequence of the known audio in another database. Therefore, based on the audio identifier associated with the approximate global audio feature, the audio segment feature sequence associated with the audio identifier may be obtained from another database, to obtain an audio segment feature sequence corresponding to the target audio to which the approximate global audio feature belongs.

For example, in the another database, a key-value pair may be stored between the audio identifier of the known audio and the audio segment feature sequence. The audio identifier is used as the key, and each audio segment feature forming the audio segment feature sequence is used as the different value. Therefore, the another database may be a key-value database.

Storage of the global audio feature and the audio segment feature sequence in the database may have a storage time limit of a specified duration. In other words, the database retains the global audio feature and the audio segment feature sequence for the specified duration. Therefore, in some embodiments, when the global audio feature and the audio segment feature sequence are stored, the storage time limit of a specified duration is automatically obtained for the currently stored global audio feature and audio segment feature sequence, and a remaining storage duration of the global audio feature and the audio segment feature sequence corresponding to the audio copy may further be updated to the specified duration, thereby helping to ensure that the database updates iteratively with new addition of an audio.

In this embodiment, based on the audio segment feature sequences respectively corresponding to the to-be-processed audio and the target audio, comparison between the audio segment feature sequences may be understood as comparing audio segment features in the audio segment feature sequences, to determine the same audio segment in the to-be-processed audio and the target audio, thereby determining an audio similarity between the to-be-processed audio and the target audio.

For example, audio segment feature contrast may be performed on the audio segment feature sequence corresponding to the to-be-processed audio and the audio segment feature sequence corresponding to the target audio, to obtain an audio similarity duration between the to-be-processed audio and the target audio, and the audio similarity between the to-be-processed audio and the target audio is determined based on audio durations respectively corresponding to the to-be-processed audio and the target audio and the audio similarity duration.

For example, a smaller duration may be first determined from the duration of the to-be-processed audio and the duration of the target audio, and then a ratio of the audio similarity duration to the smaller duration is calculated, to obtain the audio similarity between the to-be-processed audio and the target audio. For another example, the audio similarity between the to-be-processed audio and the target audio may be calculated based on a larger duration of the duration of the to-be-processed audio and the duration of the target audio. This is not limited in this embodiment.

For ease of understanding, for example, assuming that the duration of the to-be-processed audio is 110 seconds and the duration of the target audio is 120 seconds, by comparing corresponding audio segment feature sequences of the two durations, it is determined that 100 seconds of an audio, namely, an audio in a 10^{th} second to a 110^{th} second of the to-be-processed audio is similar to an audio in a 20^{th} second to a 120^{th} second of the target audio. In this case, it may be obtained that the audio similarity duration is 100 seconds, and the audio similarity is 100 seconds/min(110 seconds, 120 seconds)=91%.

In some embodiments, time axes of the audio segment feature sequence of the to-be-processed audio and the audio segment feature sequence of the target audio are aligned, to help ensure that the two audio segment feature sequences have consistent time granularities. Using a vector similarity measurement method, a similarity between the audio segment feature of the to-be-processed audio and an audio segment feature that is in the target audio and that corresponds to the same time period is calculated one by one, and a feature matching threshold is set. If the similarity between the audio segment feature of the to-be-processed audio and the audio segment feature of the target audio is greater than or equal to the feature matching threshold, the to-be-processed audio and the target audio within the time period are determined to be similar. Consecutive similar audio segments are combined into an audio similarity interval, to avoid fragmented determinations caused by fluctuation of a single segment feature. An audio similarity interval in the to-be-processed audio is converted into a first actual time interval, and an audio similarity interval in the target audio is converted into a second actual time interval. A duration of an overlapping part in the first actual time interval and the second actual time interval is used as the audio similarity duration.

For example, the audio segment feature sequence of the to-be-processed audio includes 220 feature vectors (corresponding to 110 seconds, where a segment is every 0.5 seconds), and the sequence of the target audio includes 240 feature vectors (corresponding to 120 seconds). After the vector similarities are calculated segment by segment, it is found that in a 20^{th} segment to a 220^{th} segment (corresponding to 10 seconds to 110 seconds) of the to-be-processed audio and a 40^{th} segment to a 240^{th} segment (corresponding to 20 seconds to 120 seconds) of the target audio, similarities between audio segment features of each audio segments are greater than or equal to 0.85, and these similar audio segments are continuous and uninterrupted. Therefore, these audio segments are combined into an audio similarity interval. The first actual time interval of the to-be-processed audio is 10 to 110 seconds (a duration of 100 seconds), the second actual time interval of the target audio is 20 to 120 seconds (a duration of 100 seconds), an overlapping interval of the two audio is 20 to 110 seconds, and a duration of the overlapping interval is 100 seconds, namely, an audio similarity duration is 100 seconds.

S240: Determine the target audio as an audio copy corresponding to the to-be-processed audio if the audio similarity reaches or exceeds a preset similarity (also referred to as satisfies a similarity requirement).

The preset similarity may be set based on an actual application requirement. For example, in some application scenarios having a relatively high requirement on copy detection accuracy, the preset similarity may be set to a relatively large value, such as 90%, 85%, and 80%. However, in some application scenarios having a relatively low requirement on copy detection accuracy, the preset similarity may be set to a relatively low value, such as 70% and 75%. This is not limited herein.

For example, it is assumed that two approximate global audio features are retrieved in S220, namely, two target audios are correspondingly determined, and then further comparison is performed based on the audio segment feature sequences. If it is obtained that an audio similarity between an audio segment feature sequence of one of the target audios and the audio segment feature sequence of the to-be-processed audio is relatively high, for example, higher than the preset similarity, and an audio similarity between an audio segment feature sequence of another target audio and the audio segment feature sequence of the to-be-processed audio is relatively low, for example, lower than the preset similarity, it is determined that the target audio whose audio similarity is higher than the preset similarity is the audio copy corresponding to the to-be-processed audio. It may be obtained from this that, in this embodiment, detection of a coarser granularity is first implemented through the global audio feature, and then detection of a finer granularity is implemented through the audio segment feature sequence, ensuring accuracy of the audio copy detection.

In some embodiments, sample data is collected. The sample data includes an audio copy pair (for example, a different version of a song and a clipped homologous audio) and a non-audio copy pair (for example, different songs and an unassociated audio segment), and an audio similarity between two audios in each audio pair is calculated. A similarity distribution curve is drawn based on the audio similarities between the multiple audio pairs, and a similarity threshold critical point between the audio copy pair and the non-audio copy pair is observed. For example, a threshold point at which a false positive rate (a non-copy is incorrectly determined as a copy) and a false negative rate (a copy is incorrectly determined as a non-copy) are balanced is found through a receiver operating characteristic curve (ROC), or a minimum threshold corresponding to a target indicator (for example, accuracy greater than or equal to 95%) is set, which is used as the preset similarity.

For example, 1000 audio copy pairs and 1000 non-audio copy pairs are collected, and a similarity of each audio pair is calculated. A similarity of 98% of audio copy pairs is greater than or equal to 82%, and a similarity of 99% of non-audio copy pairs is less than or equal to 78%. Through ROC curve analysis, when the preset similarity is set to 80%, the false positive rate and the false negative rate are both less than 3%. Therefore, the preset similarity is determined to be 80%.

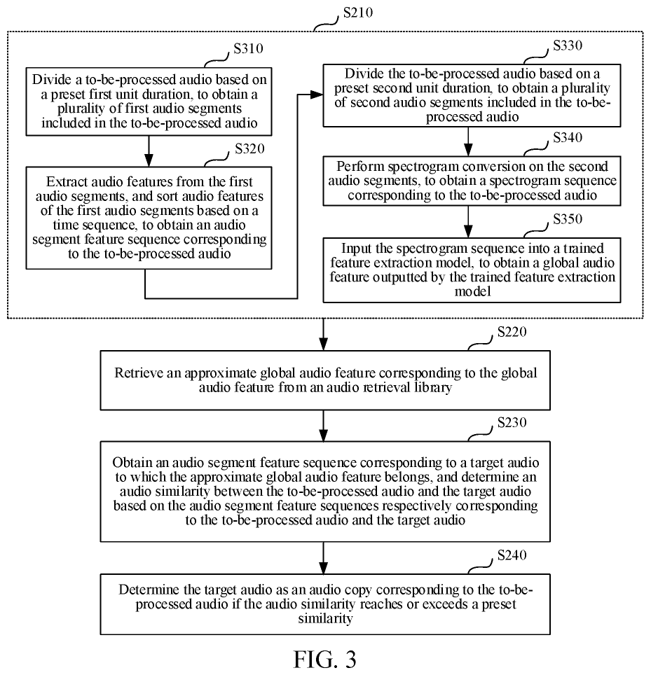

FIG. 3 is a second flowchart of an audio copy detection method according to an embodiment of this disclosure.

As shown in FIG. 3, a process of extracting the audio segment feature sequence in S210 includes the following content of S310 to S320:

S310: Divide the to-be-processed audio based on a preset first unit duration, to obtain a plurality of first audio segments included in the to-be-processed audio.

In some embodiments, the to-be-processed audio is continuously segmented according to the first unit duration starting from a starting moment of the to-be-processed audio. For example, the starting moment is a starting point of a first first audio segment, and after lasting for the first unit duration, is an end point of the first first audio segment. Segmentation is continued through an end point of the first first audio segment as a starting point of a second first audio segment, until all duration of the to-be-processed audio is covered. If total duration of the to-be-processed audio is not an integer multiple of the first unit duration, duration of the last first audio segment is remaining duration.

For example, total duration of the to-be-processed audio is 10.3 seconds, and the preset first unit duration is 1 second. Segmentation starts from 0 second, to obtain 10 complete first audio segments (respectively corresponding to 0 to 1 second, 1 to 2 seconds, . . . , and 9 to 10 seconds), and an 11^{th} first audio segment (corresponding to 10 to 10.3 seconds), for a total of 11 first audio segments.

S320: Extract audio features from the first audio segments, and sort the audio features of the first audio segments based on a time sequence, to obtain the audio segment feature sequence corresponding to the to-be-processed audio.

In S310, the first unit duration is usually a relatively small value, for example, 1 second. The to-be-processed audio is divided based on the first unit duration, to obtain a plurality of first audio segments having the first unit duration.

S320: Extract audio features from the first audio segments, and then sort the audio features of the first audio segments based on a time sequence, thereby obtaining the audio segment feature sequence corresponding to the to-be-processed audio. For example, it is assumed that total duration of the to-be-processed audio is 100 seconds and the first unit duration is 1 second, the audio segment feature sequence corresponding to the to-be-processed audio is obtained by arranging audio features of 100 first audio segments in a time sequence. It can be seen from this that the audio segment feature sequence can represent audio content of a finer granularity.

In this embodiment of this disclosure, the audio segments are divided through the fixed first unit duration, and then the audio segment features of the audio segments are arranged according to a time sequence, to help ensure that an audio segment feature sequence strictly corresponds to a time flow direction of original audio, and provide an accurate time sequence basis for subsequent comparison with the target audio segment feature sequence. The to-be-processed audio is split into a plurality of first audio segments and audio segment features are respectively extracted, so that local audio features in different time periods can be captured in detail, local detail loss caused by smoothing of global features is avoided, and detection sensitivity of local audio is improved. The division rule based on the preset first unit duration is fixed, so that different to-be-processed audio segment feature sequences have a uniform time granularity, thereby helping to ensure fairness of subsequent cross-audio comparison and repeatable verification of a result.

Still referring to FIG. 3, the process of extracting a global audio feature corresponding to the to-be-processed audio in S210 further includes the following content shown in S330 to S350:

S330: Divide the to-be-processed audio based on a preset second unit duration, to obtain a plurality of second audio segments included in the to-be-processed audio.

In some embodiments, the to-be-processed audio is continuously segmented according to the second unit duration starting from a starting moment of the to-be-processed audio. For example, the starting moment is a starting point of a first second audio segment, and after lasting for the second unit duration, is an end point of the first second audio segment. Segmentation is continued through an end point of the first second audio segment as a starting point of a second second audio segment, until all duration of the to-be-processed audio is covered. If total duration of the to-be-processed audio is not an integer multiple of the second unit duration, duration of the last second audio segment is remaining duration.

For example, total duration of the to-be-processed audio is 10.3 seconds, the preset first unit duration is 1 second, and the preset second unit duration is 2 seconds (greater than the first unit duration). Segmentation starts from 0 second, to obtain 5 complete second audio segments (respectively corresponding to 0 to 2 seconds, 2 to 4 seconds, 4 to 6 seconds, 6 to 8 seconds, and 8 to 10 seconds), and a 6^{th} second audio segment (corresponding to 10 to 10.3 seconds), for a total of 6 second audio segments.

S340: Perform spectrogram conversion on the second audio segments, to obtain a spectrogram sequence corresponding to the to-be-processed audio.

Herein, if a mute part exists in the second audio segment, mute cutting may be performed, to reserve a valid audio signal; uniform sampling rate adjustment is performed on the second audio segments, to help ensure that resolutions, in a time dimension, of time-domain signals of different second audio segments are consistent; and the following processing are performed on each preprocessed second audio segment: dividing a time-domain signal of the second audio segment into a plurality of frames based on a fixed time window, and setting an overlap between adjacent frames, to reduce inter-frame information loss; applying a window function (such as a Hanning window) to each frame signal to reduce spectrum leakage at a frame edge; performing short-time Fourier transform on each windowed frame to convert a time-domain signal into a frequency-domain signal, to obtain a spectrum of each frame; and arranging the spectra of all the frames in the same second audio segment in time sequence, to form a two-dimensional matrix (the horizontal axis is a time frame, the vertical axis is a frequency point, and a matrix element value is energy of a corresponding frequency). The two-dimensional matrix is a spectrogram corresponding to the second audio segment.

S350: Input the spectrogram sequence into a trained feature extraction model, to obtain a global audio feature outputted by the trained feature extraction model.

Because total duration of the to-be-processed audio is usually relatively large, if the global feature is directly extracted from the to-be-processed audio, load of the deep learning network is easily excessively large, resulting in crashing. Therefore, in S330, the to-be-processed audio is divided based on the second unit duration, to divide the to-be-processed audio into a plurality of second audio segments, and subsequently, the global audio feature is extracted based on the second audio segments, thereby reducing load of the deep learning network to some extent.

Therefore, based on different starting points, the second unit duration is usually greater than or equal to the first unit duration. Generally, the second unit duration is greater than the first unit duration, for example, the second unit duration may be 10 seconds. When the audio segment duration is less than the second unit duration, a second audio segment satisfying the second unit duration may be obtained by supplementing duration of the audio segment.

S340: Perform spectrogram conversion on the second audio segments, to convert a waveform of the audio time sequence into a Mel-spectrogram, thereby obtaining a spectrogram sequence corresponding to the to-be-processed audio. S350: Input the spectrogram sequence corresponding to the to-be-processed audio into the trained feature extraction model, so that a global audio feature outputted by the trained feature extraction model can be obtained.

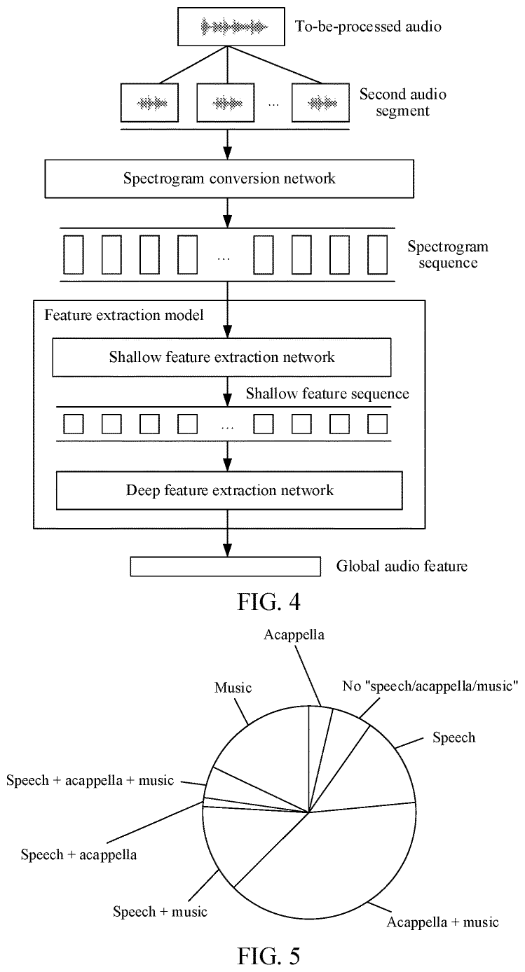

FIG. 4 is a schematic flowchart of extracting a global audio feature corresponding to a to-be-processed audio according to an embodiment of this disclosure. It can be seen that a trained feature extraction model includes a shallow feature extraction network and a deep feature extraction network that are cascaded. A spectrogram sequence corresponding to the to-be-processed audio is inputted into the trained feature extraction network. First, a shallow feature corresponding to each frequency diagram in the spectrogram sequence is extracted through the shallow feature extraction network, to correspondingly obtain a shallow feature sequence corresponding to the to-be-processed audio. Then, a deep feature corresponding to each shallow feature is extracted through the deep feature extraction network. Finally, an average feature value is calculated based on each deep feature, so that the calculated average feature value is used as the global audio feature corresponding to the to-be-processed audio. An order of the shallow feature extraction networks in the trained feature extraction model is less than an order of the deep feature extraction networks in the trained feature extraction model. For example, the shallow features are outputted by a network layer (for example, an initial convolutional layer or a processing unit near an input layer) at a front of the feature extraction model, and the deep features are outputted by a network layer (for example, a fully-connected layer or a processing unit near an output layer after a plurality of convolutional layers or pooling layers are stacked) at a back of the feature extraction model.

For ease of understanding, for example, assuming that a second unit duration is 10 seconds, each second audio segment extracts a 768-dimensional feature vector through the trained feature extraction model. Therefore, an audio feature corresponding to each second audio segment may be represented as (batch, 768). The batch is a quotient between a duration of the to-be-processed audio and the second unit duration. Then, an average value of batch dimensions is calculated, to obtain the global audio feature corresponding to the to-be-processed audio.

For example, the shallow feature extraction network may include a multilayer CNN, to learn the shallow features by using translation invariance of the CNN. The deep feature extraction network may include a Transformer (which is a deep learning model architecture configured to perform sequence to sequence operations) network, to learn the deep feature by using a long-time memory capability of the Transformer network. However, specific network structures of the shallow feature extraction network and the deep feature extraction network are not limited in this embodiment, and any combination of the shallow feature extraction network and the deep feature extraction network that can implement the foregoing functions may be used as a structure for implementation of the feature extraction model.

In this embodiment of this disclosure, a basic visual feature of a shallow network focus spectrogram is suitable for being used as an audio segment feature of a finer granularity. The shallow feature is further integrated and abstracted through a deep network, to capture a global correlation between segments, and the generated deep feature may represent an entire audio attribute. Such a hierarchical extraction mechanism enables the global audio feature and the audio segment feature sequence to respectively correspond to different abstraction levels, thereby satisfying comparison requirements of different granularities. The average value of the deep features is used as the global audio feature, so that deep feature information of a plurality of second audio segments can be integrated, thereby avoiding one-sidedness of a single second audio segment feature, more comprehensively reflecting an entire feature, and improving representativeness of the global audio feature.

Based on the network structure of the feature extraction model exemplified above, in an embodiment, the first audio segment sequence corresponding to the to-be-processed audio may be inputted into the trained feature extraction model, and the shallow feature sequence correspondingly outputted by the shallow feature extraction network may be used as an audio segment feature sequence corresponding to the to-be-processed audio in S210. In other words, the audio segment feature included in the audio segment feature sequence corresponding to the to-be-processed audio is the shallow feature. The shallow feature does not have semantics, and can more accurately express an audio framework. Therefore, after recall of a similar global audio feature is implemented by using the global audio feature, feature similarity verification is further performed through the shallow feature sequence, which can further improve accuracy of audio copy detection.

The trained feature extraction model is obtained by pre-training an initial feature extraction model through a pre-collected training data set. A pre-training process is a process of self-supervised learning. A basic idea of the self-supervised learning is performing transformation (for example, rotation, blocking, or color transformation) on sample data, so that the feature extraction model can learn useful feature representation from the transformed data.

In some embodiments, at least one training task from a reconstruction learning task and a contrastive learning task may be respectively generated, and then the at least one training task is respectively executed based on the training data set, to pre-train the initial feature extraction model to obtain a trained feature extraction model.

The reconstruction learning task indicates that model parameter optimization is performed by calculating a mean absolute error (MAE) loss value. A calculation formula of a loss function corresponding to the reconstruction learning task can be expressed as formula (1):

$$loss ( MAE ) = \frac{1}{n} {\sum }_{i = 1}^{n} \vert {y}_{i} - {\hat{y}}_{i} \vert \qquad ( 1 )$$

where n represents a quantity of samples in a training batch, ŷᵢ represents a global audio feature outputted by an initial feature extraction model, yᵢ represents a real global audio feature, loss(MAE) represents a loss function corresponding to the reconstruction learning task, and Σ is configured for summing data.

The contrastive learning task indicates that model parameter optimization is performed by calculating a noise contrastive estimation loss value. A basic idea of the contrastive learning task is to optimize a model by comparing a positive sample with a negative sample, and an objective of the model is to maximize a similarity between the positive sample and the target, while minimizing a similarity between the negative sample and the target. A loss function corresponding to the contrastive learning task may be represented as loss (InfoNCE), and a calculation formula is, for example, the formula (2):

$$loss ( InfoNCE ) = - \frac{1}{n} {\sum }_{i = 1}^{n} log \frac{{A}_{+}}{{A}_{+} + {B}_{-}} \qquad ( 2 )$$

where n represents a quantity of samples in a training batch, A₊ represents a similarity score of a positive sample pair, B_ represents a sum of similarity scores of all negative sample pairs, loss(InfoNCE) represents a loss function corresponding to the contrastive learning task, Σ is configured for summing data, and log is configured for performing a logarithmic operation.

In a training process, training stability of the feature extraction model may be improved through at least one of gradient reduction and feature penalty term. The gradient reduction is to limit a size of a gradient to avoid an extreme change of a model parameter during update, and the feature penalty item is to add an item related to model complexity to a loss function, so that a model keeps a generalization capability while performing good performance on training data.

In addition, in some embodiments, the training data may be collected in a distributed data crawling manner, to obtain a multivariate heterogeneous training data set. Further, a large-scale training data set may be configured to perform pre-training on the initial feature extraction model. For example, the training data is from different types of audio services, data related to these audio services is stored in a distributed manner, and a training data set including different types of audio data may be obtained through distributed crawling of the audio data of these audio services.

In the embodiments of this disclosure, the feature extraction model is encouraged to capture detailed information of the spectrogram through the reconstruction learning task, thereby improving a capability of restoring a local feature of the audio. The feature extraction model is promoted to distinguish a feature difference between similar and non-similar audios through the contrastive learning task, thereby enhancing a capability of distinguishing global semantics. The two tasks are combined to enable the feature extraction model to maintain stable feature extraction performance in complex audio scenarios, thereby improving a generalization capability. The reconstruction learning task is executed based on the training data set, and precision of feature extraction is directly fed back through quantization of the MAE. For the contrastive learning task, sensitivity of the feature extraction model to key features is rapidly enhanced through noise comparison estimation, parameter adjustment without the target is avoided, a training period is shortened, and model convergence quality is improved.

In an application scenario, the audio copy detection method provided in the embodiments of this disclosure is applied to a video posting platform. The video posting platform may be understood as a user generated content (UGC) platform. A user may post, on the video posting platform, a video produced by the user, or may browse, on the video posting platform, a video posted by another user.

When producing a to-be-posted video work, the user usually adds manners such as background music, a sound effect, a commentary, and a monologue to help present video content, to give a feeling of a video scenario and drive an emotional atmosphere of viewers. FIG. 5 is a schematic diagram of audio classification distribution included in a video posted by a user on a video posting platform according to an embodiment of this disclosure. It may be learned that a proportion of users posting videos by using pure music is not large, and most users are accustomed to posting videos by using combinations of a plurality of audios. In this application scenario, if audio copy detection needs to be performed, it is inaccurate to consider the background music included in a video work. Therefore, the embodiments of this disclosure further provide implementing audio copy detection based on an original sound of the video.

Global audio features corresponding to audios included in videos posted on the video posting platform are stored in an audio retrieval library, and each global audio feature has an audio identifier in the audio retrieval library. The same audio corresponds to the same audio identifier, and different audios correspond to different audio identifiers.

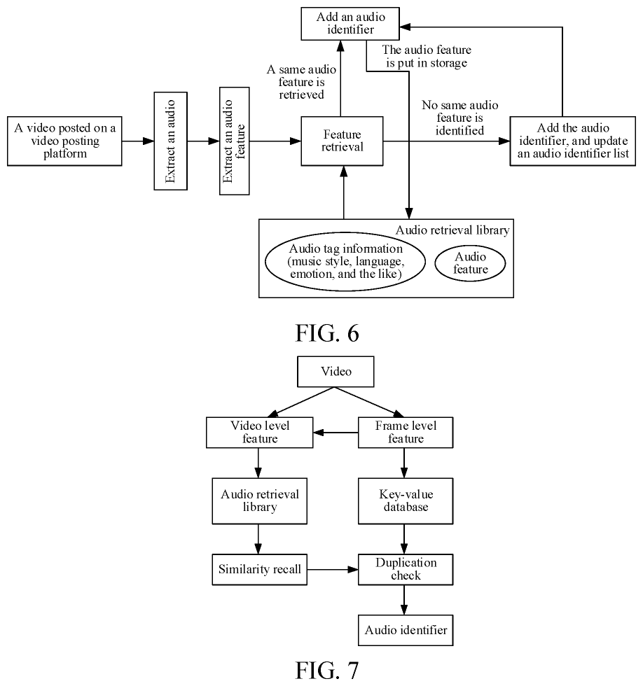

FIG. 6 is a flowchart of audio identifier processing based on a video posting platform according to an embodiment of this disclosure. It can be seen that for a video posted on a video posting platform, audio information included in the video is first extracted as a to-be-processed audio, then a global audio feature and an audio segment feature sequence corresponding to the to-be-processed audio are extracted, and then an approximate global audio feature corresponding to the global audio feature is retrieved based on an audio retrieval library. If the approximate global audio feature is retrieved, the same audio feature is retrieved, and the audio identifier corresponding to the approximate global audio feature is added as the audio identifier of the to-be-processed audio. If the approximate global audio feature is not retrieved, the audio identifier corresponding to the to-be-processed audio is generated based on a latest audio identifier in an audio identifier list.

The audio identifier list records an audio identifier corresponding to an audio included in a video posted on the video posting platform. Therefore, in this embodiment, the audio identifier corresponding to the to-be-processed audio is generated based on the latest audio identifier in the audio identifier list, to help ensure that the generated audio identifier is a new audio identifier that does not exist in the audio identifier list. For example, value update processing may be performed on the latest audio identifier in the audio identifier list based on a preset value update rule, for example, adding a preset value (for example, 1) to a value each time, and an obtained value is used as the audio identifier of the to-be-processed audio. A specific updating manner of the audio identifier is not limited in this embodiment. For example, a value added each time may be another value other than 1, or a new audio identifier may be generated in a mode of reducing the value each time.

For example, the value update rule further includes: performing a hash operation on the latest audio identifier in the audio identifier list, and using an operation result as an updated value, namely, the audio identifier corresponding to the to-be-processed audio; or using a value of a preset length from a head of the operation result as an audio identifier of the to-be-processed audio.

In this embodiment of this disclosure, when the audio similarity reaches or exceeds the preset similarity, the to-be-processed audio is endowed with the audio identifier of the audio copy, so that audios having similar content share the same audio identifier, thereby reducing data redundancy. If the audio similarity is lower than the preset similarity, the audio identifier corresponding to the to-be-processed audio is generated based on the latest audio identifier in the audio identifier list, to help ensure that the audio identifier of the to-be-processed audio is distinguished from an existing identifier, thereby implementing accurate correspondence between the audio identifier and audio content.

FIG. 7 is a schematic architectural diagram of a principle of adding an audio identifier to a video posted on a video posting platform according to an embodiment of this disclosure. For a video posted on a video posting platform, a global audio feature is extracted as a video level feature and an audio segment feature sequence is extracted as a frame level feature, then similarity recall is performed based on an audio retrieval library, to recall similar audio based on the video level feature, and duplication check is performed based on a key-value database, to implement duplication check of an audio copy based on the frame level feature, thereby adding an audio identifier for the video based on a result of the duplication check. The audio retrieval library shown in FIG. 7 is configured to store the global audio feature, and the key-value database is configured to store the audio segment feature sequence.

In addition, as shown in FIG. 6, the audio retrieval library is not only configured to store the global audio feature and the audio segment feature sequence, but also may store audio tag information, such as tag types of music style, language, and an emotion of the audio. This is not limited herein. These audio tags may distinguish, to some extent, videos to which the audio tags belong, to satisfy some video processing scenarios. For example, a video having an audio of a type of style may be quickly selected through an audio tag stored in the audio retrieval library.

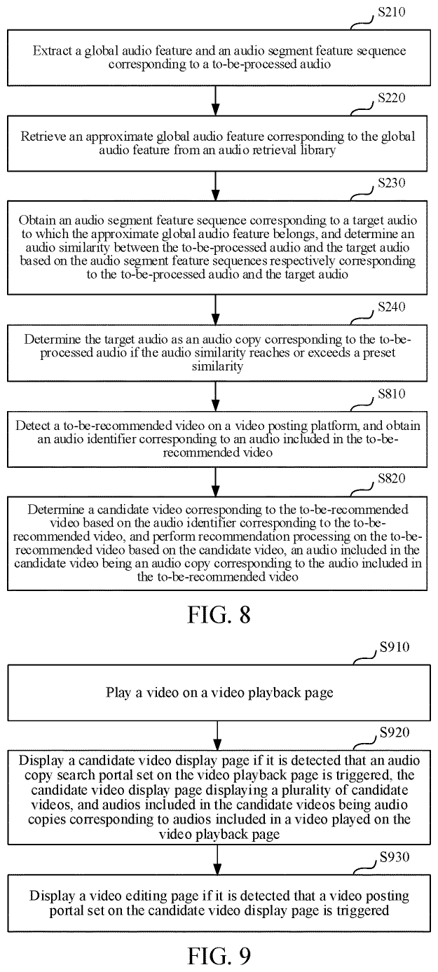

In the application scenario of the video posting platform, as shown in FIG. 8, the audio copy detection method may further include S810 to S820, which are described in detail as follows.

S810: Detect a to-be-recommended video on a video posting platform, and obtain an audio identifier corresponding to an audio included in the to-be-recommended video.

The technical solution provided in this embodiment is applied to a video recommendation scenario in the video posting platform. The to-be-recommended video in the video posting platform may be detected based on a specific recommendation requirement. For example, if a specific recommendation requirement is to perform video recommendation for a new video posted by a user, the new video posted on the video posting platform is detected as the to-be-recommended video. For another example, a specific recommendation requirement is to perform video recommendation for a video posted by a user that has a specific tag. The specific tag, for example, indicates that the user has performed at least one of a payment operation and a recharge operation on the video posting platform, and the video posted by the user that has the specific tag on the video posting platform is used as the to-be-recommended video.

The audio identifier corresponding to the audio included in the to-be-recommended video is obtained based on the exemplified process shown in FIG. 6, and details of the process are not described herein again.

S820: Determine a candidate video corresponding to the to-be-recommended video based on the audio identifier corresponding to the to-be-recommended video, and perform recommendation processing on the to-be-recommended video based on the candidate video, an audio included in the candidate video being an audio copy corresponding to the audio included in the to-be-recommended video.

Because the same or similar audio has the same audio identifier, in this embodiment, first, an audio copy whose audio identifier is the same as the audio identifier of the audio included in the to-be-recommended video is obtained, and then a video including the audio copy is obtained as a candidate video, to perform recommendation processing on the to-be-recommended video based on the obtained candidate video.

For example, viewers of the candidate video may be obtained, and the to-be-recommended video may be recommended to these viewers. Alternatively, based on watching data of these viewers for the candidate video, for example, a watching duration and evaluation information, viewers interested in the candidate video are further selected, and then the to-be-recommended video is recommended to the selected viewers. Therefore, the to-be-recommended video may be accurately recommended.

Alternatively, the to-be-recommended video and the candidate video may be packaged and recommended. For example, the to-be-recommended video and the candidate video are used as one video package. When any viewer browses any video in the video package, other videos in the video package may be recommended to the viewer based on a preset rule. The preset rule is, for example, immediately recommending to play other videos in the video package after a current video is watched, or after the current video is watched, recommending to play other videos in the video package after a preset quantity of videos are spaced. This is not limited herein.

A specific video recommendation mode is not limited in this embodiment, but video recommendation performed in this embodiment relies on audio copy identification performed on audio included in the video. After the audio is extracted from the video, audio copy detection may be performed on the extracted audio. Because the audio extracted from the video is an original audio, the original audio includes all audio information in the video, such as background music, a commentary, and a monologue, so that video recommendation performed in this embodiment considers all audio information in the video, thereby helping to ensure a good video recommendation effect.

In this embodiment of this disclosure, based on the audio identifier corresponding to the to-be-recommended video, the candidate video including the audio copy of the same audio identifier is obtained, to recommend the to-be-recommended video to viewers of the candidate video. An association relationship between the same or similar audio is used, to help ensure a matching degree between the recommended object and the to-be-recommended video, and improve recommendation accuracy. Multiple modes such as direct recommendation to the viewers of the candidate video, recommendation after screening based on watching data, and packaging and recommending the to-be-recommended video and the candidate video are supported, and a preset rule for packaging and recommending may be flexibly set, to adapt to recommendation requirements in different scenarios, and enhance diversity of recommendation policies.

In an application scenario of the video posting platform, using the audio copy detection solution provided in this embodiment of this disclosure may further improve a work posting rate on the video posting platform. In another embodiment, as shown in FIG. 9, a video processing method performed by a user terminal includes the following operations.

S910: Play a video on a video playback page.

Herein, the video playback page includes a plurality of videos, and in response to a selection operation performed on any video, a selected video is played on the video playback page. Alternatively, in response to an opening operation performed on the video playback page, a video recommended by a video platform is played. A video posting platform loads audio and video data of a video, initializes a player component on the video playback page, performs decoding and playing based on parameters such as an original frame rate and resolution of the video, and renders video images in real time and outputs an audio, so that a user can normally watch and listen to video content.

S920: Display a candidate video display page if it is detected that an audio copy search portal set on the video playback page is triggered, the candidate video display page displaying a plurality of candidate videos, and audios included in the candidate videos being audio copies corresponding to audios included in a video played on the video playback page.

S930: Display a video editing page if it is detected that a video posting portal set on the candidate video display page is triggered.

The video posting platform has a front end and a back end. The front end refers to a part that a user directly interacts with, and is mainly responsible for presenting data provided by the back end to the user in a form of a graphical interface, usually through a web browser, and processing interaction between the user and the interface. The back end is responsible for processing a request sent by the front end, executing corresponding logic (for example, accessing a database and performing data processing), and returning a result to the front end for display.

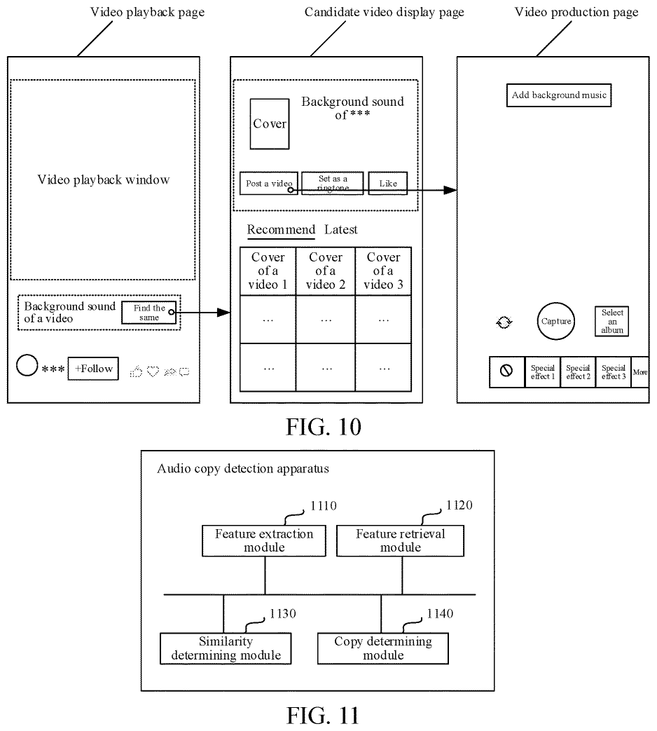

The process shown in S910 to S930 is described by using a schematic diagram of a jump of a front end interface of the video posting platform shown in FIG. 10 as an example.

The user terminal first displays the video playback page, and plays the video on the video playback page. The audio copy search portal is set on the video playback page. For example, a button “Find the same style” on the video playback page shown in FIG. 10 is the audio copy search portal. When detecting that the audio copy search portal is triggered, the user terminal jumps to display the candidate video display page.

A plurality of candidate videos are displayed on the candidate video display page. An audio included in the candidate video is an audio copy corresponding to an audio included in the video played on the video playback page. The audio identifier corresponding to the candidate video is the same as the audio identifier corresponding to the video played on the video playback page. The audio identifier corresponding to the audio included in the video is identified through the related process recorded in the foregoing embodiment.

Because the candidate videos displayed on the candidate video display page use the same or similar audio, the candidate videos may have a common content attribute. For example, the candidate videos are all funny videos and movie commentary videos. Therefore, by presenting related candidate videos on the candidate video display page, the user may be guided to create and post a video work by using the same audio to some extent, thereby improving the work posting rate on the video posting platform.

In addition, as shown in FIG. 10, the candidate video display page may further display a video cover. For example, the plurality of candidate videos displayed on the candidate video display page are video covers. The video cover may be cover content set by the user when videos are historically posted, or may be cover content directly determined from video content of the candidate videos. A manner of obtaining the video covers of the candidate videos is not limited in this embodiment.

The video posting portal is set on the candidate video display page. For example, a button “Post a video” shown in FIG. 10 is the video posting portal. When detecting that the video posting portal is triggered, the user terminal jumps to display a video production page, and the user may perform, on the video production page, a production operation performed on to-be-posted video. A specific process of video production is not limited in this embodiment. However, the same audio may be used as added background music by default on the video production page, so that the user can produce a video.

As can be obtained, in this embodiment, the page display on the front end interface of the video posting platform is combined with the audio copy detection technology, so that the user is facilitated to guide to produce and post the video based on the same audio during video watching, thereby improving the work posting rate on the video posting platform, and improving competitiveness of the video posting platform in the same type of platform products.

In this embodiment of this disclosure, through the audio copy search portal, the user may quickly find the candidate video including the similar audio, thereby expanding a content browsing range. The video posting portal lowers a threshold for the user to post associated content, and improves platform interactivity. Based on the association relationship of an audio copy, videos related to content are presented in a centralized manner on the candidate video display page, so that videos having the same or similar audio form a content cluster, thereby facilitating the user to efficiently obtain the same-type information.

FIG. 11 is a block diagram of an audio copy detection apparatus according to an embodiment of this disclosure. As shown in FIG. 11, the audio copy detection apparatus includes: a feature extraction module 1110, configured to extract a global audio feature corresponding to a to-be-processed audio, and extract an audio segment feature sequence corresponding to the to-be-processed audio; a feature retrieval module 1120, configured to retrieve an approximate global audio feature corresponding to the global audio feature from an audio retrieval library, and obtain an audio segment feature sequence corresponding to a target audio to which the approximate global audio feature belongs; a similarity determining module 1130, configured to determine an audio similarity between the to-be-processed audio and the target audio based on the audio segment feature sequence corresponding to the to-be-processed audio and the audio segment feature sequence corresponding to the target audio; and a copy determining module 1140, configured to determine the target audio as the audio copy corresponding to the to-be-processed audio if the audio similarity reaches or exceeds a preset similarity.

In another embodiment, the feature extraction module 1110 includes an audio segment feature extraction unit, where the audio segment feature extraction unit is configured to divide the to-be-processed audio based on a preset first unit duration, to obtain a plurality of first audio segments included in the to-be-processed audio; and separately extract audio features from the first audio segments, and sort the audio features of the first audio segments based on a time sequence, to obtain the audio segment feature sequence corresponding to the to-be-processed audio.

In another embodiment, the feature extraction module 1110 includes a global feature extraction unit, where the global feature extraction unit is configured to divide the to-be-processed audio based on a preset second unit duration, to obtain a plurality of second audio segments included in the to-be-processed audio, where the second unit duration is greater than or equal to the first unit duration; perform spectrogram conversion on each second audio segment, to obtain a spectrogram sequence corresponding to the to-be-processed audio; and input the spectrogram sequence into a trained feature extraction model, to obtain a global audio feature outputted by the trained feature extraction model.

In another embodiment, the trained feature extraction model is obtained by pre-training an initial feature extraction model by using a training data set. The audio copy detection apparatus further includes a model training module, where the model training module is configured to respectively generate at least one training task from a reconstruction learning task or a contrastive learning task, where the reconstruction learning task is instructed to perform model parameter optimization by calculating a mean absolute error (MAE) loss value, and the contrastive learning task is instructed to perform model parameter optimization by calculating a noise contrastive estimation loss value; and separately perform the at least one training task based on the training data set, and pre-train the initial feature extraction model, to obtain the trained feature extraction model.

In another embodiment, the trained feature extraction model includes a shallow feature extraction network and a deep feature extraction network that are cascaded. The global feature extraction unit is further configured to extract a shallow feature corresponding to each spectrogram in the spectrogram sequence through the shallow feature extraction network; extract a deep feature corresponding to each shallow feature through the deep feature extraction network; and calculate an average feature value based on the deep feature, and use the average feature value as the global audio feature corresponding to the to-be-processed audio.

In another embodiment, the audio segment feature extraction unit is further configured to input the first audio segments into the trained feature extraction model based on the time sequence; and use, as the audio segment feature sequence corresponding to the to-be-processed audio, a shallow feature sequence outputted by the shallow feature extraction network.

In another embodiment, the similarity determining module 1130 is further configured to perform audio segment feature contrasting on the audio segment feature sequence corresponding to the to-be-processed audio and the audio segment feature sequence corresponding to the target audio, to obtain an audio similarity duration between the to-be-processed audio and the target audio; and determine the audio similarity between the to-be-processed audio and the target audio based on audio durations respectively corresponding to the to-be-processed audio and the target audio, and the audio similarity duration.

In another embodiment, each global audio feature stored in the audio retrieval library has an audio identifier. The audio copy detection apparatus further includes an audio storage module, where the audio storage module is configured to use an audio identifier corresponding to the audio copy as an audio identifier corresponding to the to-be-processed audio; and store the global audio feature and the audio segment feature sequence corresponding to the to-be-processed audio into the audio retrieval library based on the audio identifier corresponding to the to-be-processed audio.

In another embodiment, the global audio feature and the audio segment feature sequence stored in the audio retrieval library each has a storage time limit of a specified duration. The audio storage module is further configured to update, to the specified duration, a remaining storage duration of the global audio feature and the audio segment feature sequence corresponding to the audio copy.

In another embodiment, the audio storage module is further configured to generate the audio identifier corresponding to the to-be-processed audio based on a latest audio identifier in an audio identifier list if the audio similarity is lower than the preset similarity.

In another embodiment, the audio copy detection apparatus further includes: a video detection module, configured to detect a to-be-recommended video on a video posting platform, and obtain an audio identifier corresponding to an audio included in the to-be-recommended video; and a video recommendation module, configured to determine a candidate video corresponding to the to-be-recommended video based on the audio identifier corresponding to the to-be-recommended video, and perform recommendation processing on the to-be-recommended video based on the candidate video, an audio included in the candidate video being an audio copy corresponding to the audio included in the to-be-recommended video.

The apparatus provided in the foregoing embodiments and the method provided in the foregoing embodiments belong to the same idea. Specific manners in which the modules and the units perform operations have been described in detail in the method embodiments. Details are not described herein again. In practical application, the audio copy detection apparatus provided by the foregoing embodiments may allocate the foregoing functions to different functional modules to be completed according to requirements. In other words, the internal structure of the apparatus is divided into different functional modules to complete all or some of the functions described above. This is not limited herein.

Embodiments of this disclosure further provide an electronic device, including one or more processors; and a memory, configured to store one or more computer programs, the one or more computer programs, when executed by the one or more processors, causing the electronic device to implement the audio copy detection method provided in the foregoing embodiments.

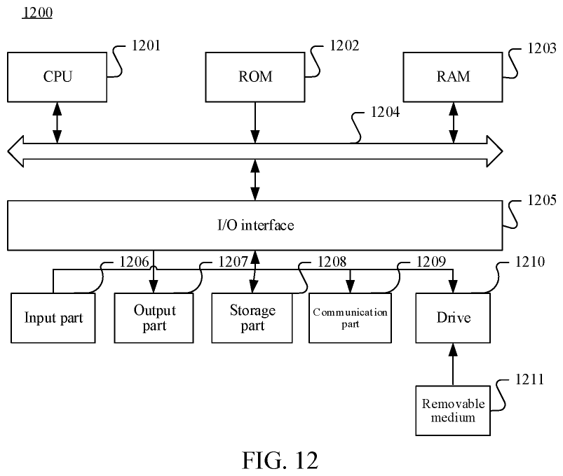

FIG. 12 is a schematic structural diagram of a computer system configured to implement an electronic device according to an embodiment of this disclosure. The electronic device may be the terminal 110 or the server 120 in the implementation environment shown in FIG. 1, or may be a terminal or a server in another implementation environment. This is not limited herein. A computer system 1200 of an electronic device shown in FIG. 12 is an example, and does not constitute any limitation on functions and a range of application of the embodiments of this disclosure.

As shown in FIG. 12, the computer system 1200 includes a central processing unit (CPU) 1201, which may perform various suitable actions and processing based on a computer program stored in a read-only memory (ROM) 1202 or a computer program loaded from a storage part 1208 into a random access memory (RAM) 1203, for example, perform the method described in the foregoing embodiments. The RAM 1203 further stores various computer programs and data required for system operation. The CPU 1201, the ROM 1202, and the RAM 1203 are connected to each other through a bus 1204. An input/output (I/O) interface 1205 is also connected to the bus 1204.

The following components are connected to the I/O interface 1205: an input part 1206 including a keyboard, a mouse, or the like; an output part 1207 including a cathode ray tube (CRT), a liquid crystal display (LCD), a speaker, or the like; a storage part 1208 including a hard disk, or the like; and a communication part 1209 including a network interface card such as a local area network (LAN) card or a modem. The communication part 1209 performs communication processing through a network such as the Internet. A drive 1210 is also connected to the I/O interface 1205 as required. A removable medium 1211 such as a magnetic disk, an optical disk, a magneto-optical disk, or a semiconductor memory is installed on the drive 1210 as required, so that a computer program read from the removable medium is installed into the storage part 1208 as required.

In some examples, according to the embodiments of this disclosure, the process described above with reference to the flowchart may be implemented as a computer software program. For example, an embodiment of this disclosure includes a computer program product. The computer program product includes a computer program carried on a computer-readable medium. The computer program includes a computer program configured to perform a method shown in the flowchart. In such an embodiment, the computer program may perform at least one of the following processes: the computer program is uploaded and installed from the network through the communication part 1209, or the computer program is installed from the removable medium 1211. When the computer program is executed by the CPU 1201, the various functions defined in the system of this disclosure are executed.

The computer-readable medium shown in the embodiments of this disclosure may be a computer-readable signal medium, a computer-readable storage medium, or any combination of the above. A more specific example of the computer-readable storage medium may include but is not limited to: an electrical connection having one or more wires, a portable computer disk, a hard disk, a RAM, a ROM, an erasable programmable ROM (EPROM), a flash memory, an optical fiber, a portable compact disk ROM (CD-ROM), an optical storage device, a magnetic storage device, or any appropriate combination of the above. The computer program included in the computer-readable medium may be transmitted by using any suitable medium, including but not limited to a wireless medium, a wired medium, or the like, or any suitable combination of the above.

The flowcharts and the block diagrams in the drawings illustrate possible system architectures, functions, and operations that may be implemented by a system, a method, and a computer program product according to various embodiments of this disclosure. Each block in the flowcharts or the block diagrams may represent a module, a program segment, or a part of code. The module, the program segment, or the part of code includes one or more executable instructions configured to implement specified logic functions. In some alternative implementations, functions annotated in the blocks may also be executed in an order different from that annotated in the accompanying drawings. For example, two blocks shown in succession may actually be performed substantially in parallel, or may sometimes be performed in a reverse order, which depends on the functions involved. Each block in a block diagram and/or a flowchart and a combination of blocks in the block diagram and/or the flowchart may be implemented by using a dedicated hardware-based system configured to perform a specified function or operation, or may be implemented by using a combination of dedicated hardware and a computer instruction.

The involved units described in the embodiments of this disclosure may be implemented by software or hardware, and the described units may alternatively be arranged in a processor. Names of the units do not constitute a limitation on the units in a specific case.

Another aspect of this disclosure further provides a computer-readable storage medium, having a computer program stored therein, and the computer program, when executed by a processor of an electronic device, implementing the audio copy detection method described above. The computer-readable storage medium may be included in the electronic device described in the foregoing embodiments, or may exist alone without being installed into the electronic device.

Another aspect of this disclosure further provides a computer program product, the computer program product including a computer program, the computer program being stored in a computer-readable storage medium. A processor of an electronic device reads the computer program from the computer-readable storage medium, and the processor executes the computer program, so that the electronic device performs the audio copy detection method provided in foregoing various embodiments.

The foregoing descriptions are embodiments of this disclosure, and are not intended to limit the implementations of this disclosure. Variations or modifications may be made with ease according to the main concept and spirit of this disclosure. Therefore, the scope of this disclosure needs to be subject to the scope of the claims.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing disclosure includes some embodiments of this disclosure which are not intended to limit the scope of this disclosure. Other embodiments shall also fall within the scope of this disclosure.

What is claimed is:

1. A method of audio copy detection, the method comprising:
extracting a first global audio feature of a first audio, and a first audio segment feature sequence of the first audio, the first global audio feature indicating an attribute of the first audio as a whole, and the first audio segment feature sequence indicating time-based local features in the first audio;
retrieving an approximate global audio feature corresponding to the first global audio feature from an audio retrieval library, the approximate global audio feature being associated with a target audio;
obtaining a second audio segment feature sequence of the target audio;
determining an audio similarity between the first audio and the target audio based on the first audio segment feature sequence of the first audio and the second audio segment feature sequence of the target audio; and
determining the target audio as an audio copy of the first audio when the audio similarity satisfies a requirement.

2. The method according to claim 1, wherein the extracting comprises:
dividing the first audio based on a preset first unit duration, to obtain a plurality of first audio segments in the first audio;
extracting audio features from the plurality of first audio segments; and
sorting the audio features of the plurality of first audio segments based on a time sequence, to obtain the first audio segment feature sequence of the first audio.

3. The method according to claim 2, wherein the extracting further comprises:
dividing the first audio based on a preset second unit duration, to obtain a plurality of second audio segments comprised in the first audio, the preset second unit duration being greater than or equal to the preset first unit duration;
performing spectrogram conversions on the plurality of second audio segments, to obtain a spectrogram sequence of spectrograms for the plurality of second audio segments in the first audio; and
inputting the spectrogram sequence into a trained feature extraction model to cause the trained feature extraction model to output the first global audio feature.

4. The method according to claim 3, wherein the trained feature extraction model is obtained by pre-training of an initial feature extraction model using a training data set, and the method further comprises:
generating at least one training task from a reconstruction learning task and a contrastive learning task, the reconstruction learning task performing model parameter optimization by calculating a mean absolute error (MAE) loss value, and the contrastive learning task performing model parameter optimization by calculating a noise contrastive estimation loss value; and
performing the at least one training task based on the training data set during the pre-training of the initial feature extraction model, to obtain the trained feature extraction model.

5. The method according to claim 3, wherein the trained feature extraction model comprises a shallow feature extraction network and a deep feature extraction network that are cascaded, and the extracting further comprises:
extracting respective shallow features of the spectrograms in the spectrogram sequence through the shallow feature extraction network;
extracting respective deep features of the shallow features through the deep feature extraction network; and
calculating an average feature value based on the deep features to be the first global audio feature of the first audio.

6. The method according to claim 5, wherein
the extracting further comprises:
inputting the plurality of first audio segments into the trained feature extraction model based on the time sequence to cause the shallow feature extraction network to output shallow audio features in the time sequence; and
the shallow audio features are used in the time sequence as the first audio segment feature sequence of the first audio.

7. The method according to claim 3, wherein the performing the spectrogram conversion comprises:
dividing a time-domain signal of a second audio segment of the plurality of second audio segments into a plurality of frames based on a preset time window;
performing Fourier transforms on the plurality of frames, to obtain respective spectra of the plurality of frames; and
combining, based on a frame time sequence of the plurality of frames, the spectra of the plurality of frames into a spectrogram of the second audio segment.

8. The method according to claim 1, wherein the determining the audio similarity comprises:
performing an audio segment feature comparison on the first audio segment feature sequence of the first audio and the second audio segment feature sequence of the target audio, to obtain an audio similarity duration between the first audio and the target audio; and
determining the audio similarity between the first audio and the target audio based on respective audio durations of the first audio and the target audio, and the audio similarity duration.

9. The method according to claim 1, wherein
the audio retrieval library includes a plurality of global audio features with respective audio identifiers;
an audio identifier of the target audio that is determined to be the audio copy of the first audio is used as an audio identifier of the first audio; and
the method further comprises:
storing the first global audio feature and the first audio segment feature sequence of the first audio into the audio retrieval library based on the audio identifier of the first audio.

10. The method according to claim 9, wherein the method further comprises:
updating, a remaining storage duration of the first global audio feature and the first audio segment feature sequence according to a storage time limit.

11. The method according to claim 9, further comprising:
when the audio similarity fails to satisfy the requirement, generating a new audio identifier for the first audio based on a latest audio identifier in an audio identifier list.

12. The method according to claim 11, wherein the generating the new audio identifier comprises:
applying a preset value update rule to the latest audio identifier in the audio identifier list to obtain an updated value to be the new audio identifier for the first audio, the preset value update rule comprising at least one of:
adding the latest audio identifier in the audio identifier list by a first preset value;
decreasing the latest audio identifier in the audio identifier list by a second preset value; and
performing a hash operation on the latest audio identifier in the audio identifier list.

13. The method according to claim 9, further comprising:
detecting a to-be-recommended video on a video posting platform, the to-be-recommended video including an audio;
obtaining an audio identifier of the audio in the to-be-recommended video;
determining a candidate video related to the to-be-recommended video based on the audio identifier of the to-be-recommended video, the candidate video including an audio copy of the audio in the to-be-recommended video; and
performing recommendation processing on the to-be-recommended video based on the candidate video.

14. The method according to claim 13, wherein, in the detecting,
a new video posted on the video posting platform is used as the to-be-recommended video; and
a video posted by a user with a specific tag is used as the to-be-recommended video, the specific tag indicating that the user has performed at least one of a payment operation and a recharge operation on the video posting platform.

15. An apparatus for audio copy detection, comprising processing circuitry configured to:
extract a first global audio feature of a first audio, and a first audio segment feature sequence of the first audio, the first global audio feature indicating an attribute of the first audio as a whole, and the first audio segment feature sequence indicating time-based local features in the first audio;
retrieve an approximate global audio feature corresponding to the first global audio feature from an audio retrieval library, the approximate global audio feature being associated with a target audio;
obtain a second audio segment feature sequence of the target audio;
determine an audio similarity between the first audio and the target audio based on the first audio segment feature sequence of the first audio and the second audio segment feature sequence of the target audio; and
determine the target audio as an audio copy of the first audio when the audio similarity satisfies a requirement.

16. The apparatus according to claim 15, wherein the processing circuitry is configured to:
divide the first audio based on a preset first unit duration, to obtain a plurality of first audio segments in the first audio;
extract audio features from the plurality of first audio segments; and
sort the audio features of the plurality of first audio segments based on a time sequence, to obtain the first audio segment feature sequence of the first audio.

17. The apparatus according to claim 16, wherein the processing circuitry is configured to:
divide the first audio based on a preset second unit duration, to obtain a plurality of second audio segments comprised in the first audio, the preset second unit duration being greater than or equal to the preset first unit duration;
perform spectrogram conversions on the plurality of second audio segments, to obtain a spectrogram sequence of spectrograms for the plurality of second audio segments in the first audio; and
input the spectrogram sequence into a trained feature extraction model to cause the trained feature extraction model to output the first global audio feature.

18. The apparatus according to claim 17, wherein the trained feature extraction model is obtained by pre-training of an initial feature extraction model with a training data set, the processing circuitry is configured to:
generate at least one training task from a reconstruction learning task and a contrastive learning task, the reconstruction learning task performing model parameter optimization by calculating a mean absolute error (MAE) loss value, and the contrastive learning task performing model parameter optimization by calculating a noise contrastive estimation loss value; and
perform the at least one training task based on the training data set during the pre-training of the initial feature extraction model, to obtain the trained feature extraction model.

19. The apparatus according to claim 17, wherein the trained feature extraction model comprises a shallow feature extraction network and a deep feature extraction network that are cascaded, and the processing circuitry is configured to:
extract respective shallow features of the spectrograms in the spectrogram sequence through the shallow feature extraction network;
extract respective deep features of the shallow features through the deep feature extraction network; and
calculate an average feature value based on the deep features to be the first global audio feature of the first audio.

20. A non-transitory computer-readable storage medium storing instructions which when executed by a processor cause the processor to perform:
extracting a first global audio feature of a first audio, and a first audio segment feature sequence of the first audio, the first global audio feature indicating an attribute of the first audio as a whole, and the first audio segment feature sequence indicating time-based local features in the first audio;
retrieving an approximate global audio feature corresponding to the first global audio feature from an audio retrieval library, the approximate global audio feature being associated with a target audio;
obtaining a second audio segment feature sequence of the target audio;
determining an audio similarity between the first audio and the target audio based on the first audio segment feature sequence of the first audio and the second audio segment feature sequence of the target audio; and
determining the target audio as an audio copy of the first audio when the audio similarity satisfies a requirement.
